(19) United States
(12) Patent Application Publication
(10) Pub. No.: US 2025/0089090 A1
(43) Pub. Date: Mar. 13, 2025

(54) DEVICES, SYSTEMS AND METHODS FOR ACTIVATING SECOND WIRELESS DEVICE TO MITIGATE AGGRESSIVE MEDIUM OCCUPIER

(71) Applicant: Cypress Semiconductor Corporation, San Jose, CA (US)

(72) Inventors: Young San Kim, Deogyang-gu (KR); Hyun Jong Lee, Seocho-gu (KR); Jeong Won Woo, Gunpo-si (KR)

(73) Assignee: Cypress Semiconductor Corporation, San Jose, CA (US)

(21) Appl. No.: 18/465,884

(22) Filed: Sep. 12, 2023

(51) Int. Cl. H04W 74/08

(52) U.S. Cl. CPC H04W 74/0816; H04W 84/12

(57) ABSTRACT

A method can include, by operation of a first wireless device operating on a channel of a wireless network, determining if another wireless device, operating outside of the wireless network, is interfering with operations of the first wireless device on the channel. In response to determining that another wireless device is interfering with operations, activating a second wireless device to execute a mitigation operation to improve the first wireless device access to the channel. Following the activation of the second wireless device, in response to the first wireless device determining that the other wireless device is not interfering with its operations, deactivating the second wireless device. Corresponding devices and systems are also disclosed.

### TECHNICAL FIELD

The present disclosure relates generally to wireless systems, and more particularly to systems that operate in environments where other wireless devices can excessively occupy a medium to the detriment of other wireless devices.

### BACKGROUND

Many wireless devices contend for a transmission medium according to a media access control procedure, such as carrier-sense multiple access with collision avoidance (CSMA/CA). In such systems, a wireless device can monitor a desired medium (e.g., channel of a bandwidth), and upon determining the medium is not active, request control of the medium (e.g., transmit a request-to-send, RTS). If such a request is granted (e.g., a clear-to-send, CTS, is received), the device can take control over the medium. In contrast, if a device receives a communication from another device requesting control of a medium, it can set a timer (e.g., network allocation vector, NAV) by which it will refrain from accessing to the medium.

Provided all wireless devices contending for the same medium have sufficiently limited bandwidth needs, communications can occur without degradation. However, in current wireless environments, there can exist devices that are “aggressive” in medium use. For example, fixed wireless access devices (FWAs) are known that can repeatedly transmit “no acknowledgement” (no ack) packets that can indicate relatively long NAVs, resulting in the medium being unavailable for nearby devices for relatively long periods of time. One type of FWA, wireless video surveillance devices, are known to transmit no ack packets with 6 ms durations that are transmitted every 3-4 ms. Such aggressive medium use devices can result in regions where other wireless devices cannot access a desired medium or have only very limited use of the medium.

### SUMMARY OF DISCLOSURE

Embodiments can include, by operation of a first wireless device operating on a channel of a wireless network, determining if another wireless device, operating outside of the wireless network, is interfering with operations of the first wireless device on the channel. In response to determining that another wireless device is interfering with operations, a second wireless device can be activated to execute a mitigation operation to improve the first wireless device access to the channel. Following the activation of the second wireless device, in response to the first wireless device determining that the other wireless device is no longer interfering with its operations, the second wireless device can be deactivated. Corresponding devices and systems are also disclosed.

### BRIEF DESCRIPTION OF THE DRAWINGS

FIG. 1 is a block diagram of a system according to an embodiment.

FIG. 2 is a block diagram of a system according to another embodiment.

FIG. 3 is a block diagram of a device that can include a station device function and an access point function according to an embodiment.

FIG. 4 is a timing diagram showing operations of a system according to an embodiment.

FIG. 5 is a block diagram of a wireless device according to an embodiment.

FIG. 6 is a block schematic diagram of a wireless device according to another embodiment.

FIGS. 7A to 7C are diagrams showing operations of an automobile system according to an embodiment.

FIG. 8 is a diagram of an integrated circuit device according to an embodiment.

FIG. 9 is a diagram of an automobile system according to an embodiment.

FIG. 10 is a flow diagram of a method according to an embodiment.

FIG. 11 is a flow diagram of a method according to another embodiment.

### DETAILED DESCRIPTION

According to embodiments, a wireless system can include a first device that can monitor a wireless channel for interference from another device that is not part of its wireless network. If such interference is detected, the first wireless device can activate a second wireless device to execute mitigation operations to reduce the interference on the channel. When the interference is no longer detected, the first wireless device can deactivate the second wireless device.

In some embodiments, a first device can be a station device (STA) that is compatible with one or more IEEE 802.11 wireless standards, and the activated second device can be an access point device (AP) that is compatible with the IEEE 802.11 wireless standard. In some embodiments, the AP can be a soft AP, activated by executing code that provides the AP function.

In some embodiments, while a first wireless device detects interference, a second wireless device can provide mitigation operations without having detected the interference.

In some embodiments, a first device can detect interference by determining that the interfering device has reserved the medium for longer than a predetermined amount of time.

In some embodiments, a first device can store information on the interfering device and forward such information to the second device when activating the mitigation operations.

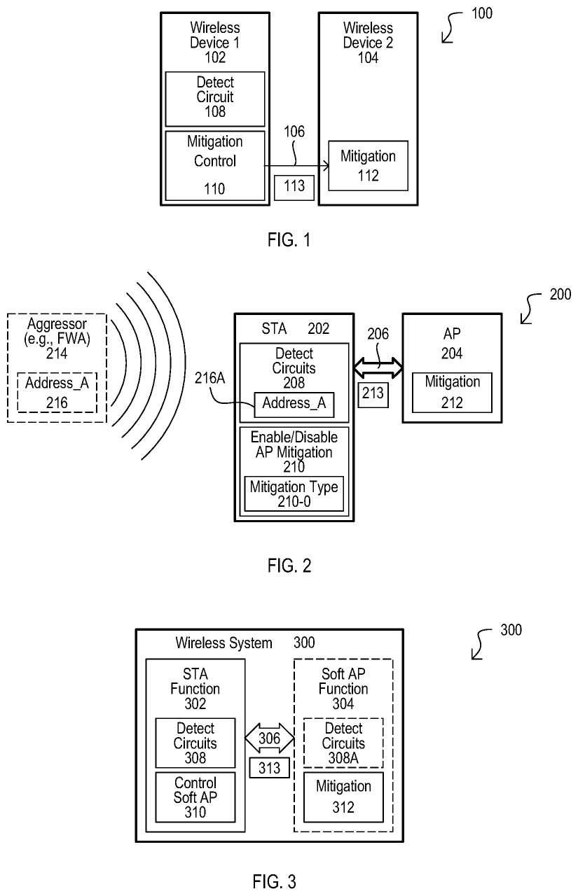

FIG. 1 is a block diagram of a system 100 according to an embodiment. A system 100 can include a first wireless device 102 and a second wireless device 104. First and second wireless devices 102/104 can operate according to one or more wireless communication standards and can be different entities according to such standards. In some embodiments, first and second wireless devices 102/104 can have different network addresses when active. First wireless device 102 can communicate with second wireless device 104 over a communication path 106 that can be a wired communications path, wireless connection or a combination thereof.

A first wireless device 102 can transmit and receive messages on a medium, which in some embodiments can include one or more frequencies. In some embodiments, a medium can be a channel formed by a range of frequencies. A first wireless device 102 can include detect circuits 108 that can detect other “aggressive” wireless devices that can interfere with its operation on the medium. This can include detecting another wireless device that reserves and/or transmits on the medium for more than a predetermined amount of time or has been determined to be a particular type of aggressor device. Such an aggressor device can be identified in any suitable fashion, including but not limited to its network identifier (e.g., IP or MAC address), its transmission pattern or a type of transmission.

In some embodiments, a first wireless device 102 does not include mitigation capabilities (i.e., operations that can address interference from an aggressive device), and so can activate mitigation capabilities present in a second device 104. A first wireless device 102 can include mitigation control circuits 110, which can transmit mitigation control signals 113 to a second wireless device 104 to enable and disable mitigation operations by the second device 104. Such mitigation control signals can take any suitable form, including wired or wireless signals. When interference is detected, first wireless device 102 can generate mitigation control signals 113 that cause second wireless device 104 to generate mitigating transmissions. When interference is no longer detected, first wireless device 102 can generate mitigation control signals 113 that cause second wireless device 104 to stop generating mitigating transmissions.

Second wireless device 104 can include mitigation circuits 112, which can generate mitigation transmissions for reducing or stopping interference from an aggressive device. Such mitigation transmissions can take any suitable form, including but not limited to commands that can control and/or affect operations of devices monitoring the channel and/or communications to first wireless device 102 that include data that can indicate actions for execution by a first wireless device 102. In some embodiments, a second wireless device can include detect circuits (not shown) but may not detect interference detected by a first device 102.

In this way, a first wireless device can detect interference in a channel resulting from another wireless device, and in response, activate a second wireless device to generate mitigating transmissions. When such interference is no longer detected, the first wireless can deactivate the second wireless device from generating mitigating transmissions.

FIG. 2 is a block diagram of a system 200 according to another embodiment. A system 200 can include a STA 202 compatible with one or more IEEE 802.11 wireless standards (referred to herein as Wi-Fi), and a Wi-Fi compatible AP 204. FIG. 2 also shows an aggressor device 214 that can aggressively reserve and/or transmit on a same channel used by STA 202. Aggressive use/reservation of a channel by an aggressor device 214 can include using a channel over a duration and/or with a frequency that can interfere with operations of STA 202. An aggressor device 214 can have a network address 216 (e.g., source address). STA 202 and AP 204 are understood to also have their own network addresses, but such addresses are not shown to avoid cluttering the view.

A STA 202 can have access to multiple channels of a band and can operate on the band according to a Wi-Fi standard. STA 202 can include detection circuits 208 and mitigation control circuits 210. Detection circuit 208 can detect transmissions (e.g., interference) from aggressor device 214 and determine when such transmissions should be subject to mitigation operations. Such detection can take the form of any of those described herein, including but not limited to a pattern of transmissions, a type of transmission, a duration of transmission, a source (e.g., address) of transmission(s), a destination (e.g., address) of transmission(s) and combinations thereof. In the embodiment shown, detect circuits 208 can determine and store the address 216A of an aggressive device 214. Mitigation control circuits 210 can generate messages for enabling or disabling mitigation actions by an AP device 204. In the embodiment shown, mitigation control circuits 210 can determine and include a mitigation type 210-0. A mitigation type 210-0 can be determined based on the type of transmissions detected by detection circuits 208. In some embodiments, a mitigation type 210-0 can be a type of mitigation determined to best address a detected aggressive behavior of aggressor device 214.

Mitigation control circuits 210 can transmit messages 213 to AP 204 that can result in AP 204 starting or stopping mitigation operations. In some embodiments, a message 213 can include an address of an aggressive device 214 and/or a mitigation type 210-0.

AP 204 can execute any suitable Wi-Fi AP function, including but not limited to receiving information from other STAs and controlling access to a basic service set (BSS). In some embodiments, an AP 204 can relay wireless traffic for different STAs of its BSS. In some embodiments, AP 204 can broadcast a service set identifier (SSID) to inform other STAs of its BSS. However, in other embodiments, AP 204 can operate as a hidden AP, and not broadcast an SSID.

According to embodiments, AP 204 can include mitigation circuits 212 that can be activated and deactivated in response to communications (e.g., message 213). In some embodiments, a type of mitigation executed by mitigation circuits 212 can depend on information provided by STA 202 (e.g., address of aggressive device 216C, mitigation type 210-0).

In this way, when a STA in a Wi-Fi system detects an aggressive or interfering wireless device, the STA can activate mitigation operations of an AP of the same service set.

FIG. 3 is a diagram of a system 300 according to another embodiment. A system 300 is capable of providing multiple wireless device functions, including a STA function 302 and an AP function 304. A STA function 302 can include detect circuits 308 and softAP control circuits 310. Detect circuits 308 can detect aggressive devices that affect a STA's channel, as described herein and equivalents. SoftAP control circuits 310 control operations of a softAP, such as mitigation functions inherent in the soft AP, that can address interference/aggressive behavior of another wireless device on a channel. In some embodiments, softAP control circuits 310 can start-up a softAP function 304 and shut-down a soft AP function 304.

A softAP function 304 can execute any suitable AP functions, as described herein or equivalents. SoftAP function 304 can include mitigation circuits 312. Mitigation circuits 312 can perform mitigation operations as described herein and equivalents. Optionally, softAP function 304 can include detect circuits 308A, which can detect aggressive/interfering devices as described herein and equivalents. In some embodiments, when a softAP function 304 is started up by a STA function 302, the softAP function 304 can activate mitigation circuits 312, regardless of whether the softAP function 304 itself has detected any interference/aggressive channel reservation. In some embodiments, if a softAP function 304 is activated and detects an aggressive/interfering device, the softAP function 304 can activate its own mitigation circuits 312.

In this way, in a wireless system that can provide both a STA function and an AP function, when a STA function detects and aggressive/interfering device, it can activate an AP function to have access to mitigation operations of the AP function.

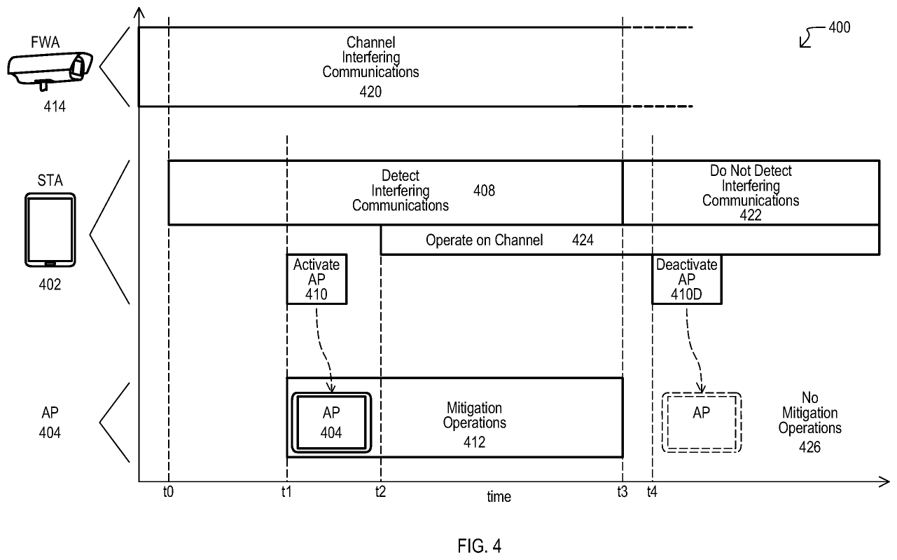

FIG. 4 is a timing diagram showing operations of a system 400 according to an embodiment. FIG. 4 shows operations of an aggressive/interfering device 414, a STA 402, and an AP 404. An interfering device 414 can emit channel interfering communications 420 as described herein or equivalents.

At about time t0, a STA 402 can detect interfering communications 408. Such detection operations can take the form of any of those described herein, or equivalents.

At about time t1, following the detection of interference/aggressive channel reservation, a STA 402 can activate mitigation operations in AP 404. In the embodiment shown, there can be a delay between detection of interference and activation of AP mitigation. Thus, at about time t1, STA 402 can generate an AP activation message 410. Such a message can take the form of any of those described herein, or equivalents. In response to AP activation message 410, an AP 404 can begin mitigation operations 412.

At about time t2, following the activation of mitigation operations 412, a STA 402 can begin operations on a channel 424. In some embodiments, a channel 424 can be the same channel that interfering device 414 is sending communications. However, in other embodiments, interference from device 414 can arise from communications on a different channel.

At about time t3, a STA 402 no longer detects interfering communications 422. Such a condition can arise out of a STA 402 moving out of range of the interfering device 414 or vice versa. When interference/aggressive channel reservation is no longer detected 422, a STA 402 can deactivate mitigation operations in AP 404. In the embodiment shown, there can be a delay between no longer detecting interference and the deactivation of AP mitigation. Thus, at about time t4, STA 402 can generate a AP deactivation message 410D. In response to AP deactivation message 410D, AP 404 can cease mitigation operations 426.

In this way, a STA can activate an AP mitigation operation a delay after detecting interference and deactivate the AP mitigation operation a delay after interference is no longer detected.

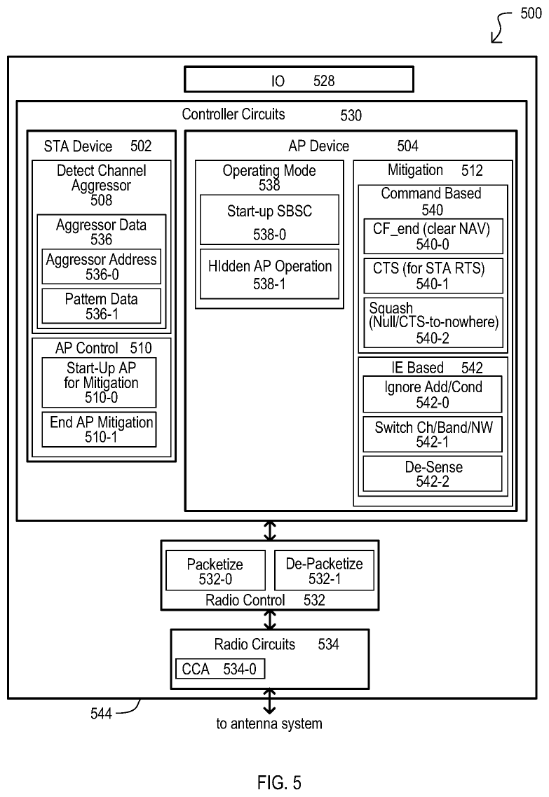

While embodiments can include various operations and systems described herein, embodiments can also include devices that execute such methods and operations. FIG. 5 is a block diagram of a device 500 according to an embodiment. A device 500 can include input/output (IO) circuits 528, controller circuits 530, radio control circuits 532 and radio circuits 534. IO circuits 528 can enable other devices and systems to communicate with a device 502 and can take any suitable form including but not limited to a serial interface and/or parallel interface.

Controller circuits 530 can include a STA function 502 and an AP function 504. A STA function 502 can include aggressor detection circuits 508 and AP control circuits 510. Aggressor detection circuit 508 can store, or have access to, aggressor data 536. Aggressor data 536 can include an aggressor address 536-0 and pattern data 536-1. An aggressor address 536-0 can include a network address for an aggressor device, including but not limited to a MAC address. Pattern data 536-1 can be recorded by a STA function 502 and used to determine if a device on a desired channel is an interfering and/or aggressive device. AP control circuits 510 can include a start-up AP mitigation function 510-0 and end AP mitigation function 510-1.

AP function 504 can include circuits for executing operating modes 538 and mitigation operations 512. Operating modes 538 can include a same band same channel (SBSC) function 538-0 and hidden AP function 538-1. In some embodiments, when a STA function 502 starts-up the AP function 504, the AP function 504 can initiate the SBSC function 538-0. This result in the AP function 504 to begin operations in the same band and same channel as the AP function 504 (and hence the same channel on which interference has been detected). In some embodiments, when a STA function 502 starts-up the AP function 504, the AP function 504 can initiate the hidden AP function 538-1, so that the AP function 504 does not transmit an SSID.

Mitigation operations 512 can include transmissions on a channel to mitigate adverse effects of an interfering/aggressive device. Mitigation operations 512 can include command based mitigation operations 540 and/or information element (IE) based operations 542. Command based mitigation operations 540 can include, but are not limited to, transmitting a contention free end control frame (CF_end) 540-0, transmitting a clear-to-send (CTS) control frame 540-1, or a “squashing” action 540-2. A CF_end control frame 540-0 can result in a STA function 502 clearing a NAV value caused by an aggressive device, and thus causing STA function 502 to access the medium. A CTS control frame can be issued in response to a request-to-send (RTS) control frame from a STA function 502. Such an RTS can be issued by AP function 504 regardless of any existing channel reservations put forth by an interfering/aggressive device. A squashing action 540-2 can include AP function 504 making transmissions based on pattern data 536-1 to interfere with transmissions from an aggressor device. Squashing action 540-2 transmissions can include, but are not limited to, a null data frame or “CTS-to-nowhere” frame.

IE based operations 542 can include transmitting packets, or wired messages, with data in a payload (e.g., PDU) that indicates actions for a STA (e.g., 502). Such actions can include, but are not limited to, having the STA ignore an address/condition 542-0, having the STA switch medium 542-1, and having a STA de-sensitize receiving levels 542-2. Ignoring an address/condition 542-0 can include sending a data frame that includes an IE with an aggressor address (e.g., 536-0). A receiving device, such as STA 502, can then ignore transmissions, such as channel reservations originating from the provided address. Ignoring an address/condition 542-0 can also include ignoring results from an assessment of a channel, such as a clear channel assessment (CCA) described in more detail below. Switching a medium 542-1 can include sending a transmission with an IE that can direct a STA (e.g., 502) to switch the band and/or channel on which it is operating, to thus avoid an interfering/aggressive reservation transmission. De-sensing 542-2 can include sending an IE directing a STA (e.g., 502) to reduce reception capabilities on the channel. IE based operations 542 can include sending communications addressed to single STAs and/or sending multi-cast communications.

While embodiments like that of FIG. 5 can include an AP function 504 sending transmissions addressed to a STA, alternate embodiments can include sending equivalent signals over a wired connection to an AP function 502.

Radio control circuits 532 can format data for transmission and upon reception, according to one or more wireless standards. In some embodiments, radio control circuits 532 can include packetizing functions 532-0 and de-packetizing functions 532-0. Radio control circuits 532 can also control operations of radio circuits 534. Radio circuits 534 can transmit and receive data according to a Wi-Fi or any other suitable wireless standard, including public and/or private standards. Radio circuits 534 can also include clear channel assessment (CCA) circuits 534-0, that generates an indication of transmissions on a channel of interest. In some embodiments, STA function 502 can ignore CCA 534-0 determinations that indicate a channel is busy in response to a mitigation communication from AP function 504.

In some embodiments a device 500 can be formed with a same integrated circuit substrate 544.

In this way, a wireless device can include a STA function that, upon detecting an interfering/aggressive device, can start-up an AP function that can execute mitigation operations.

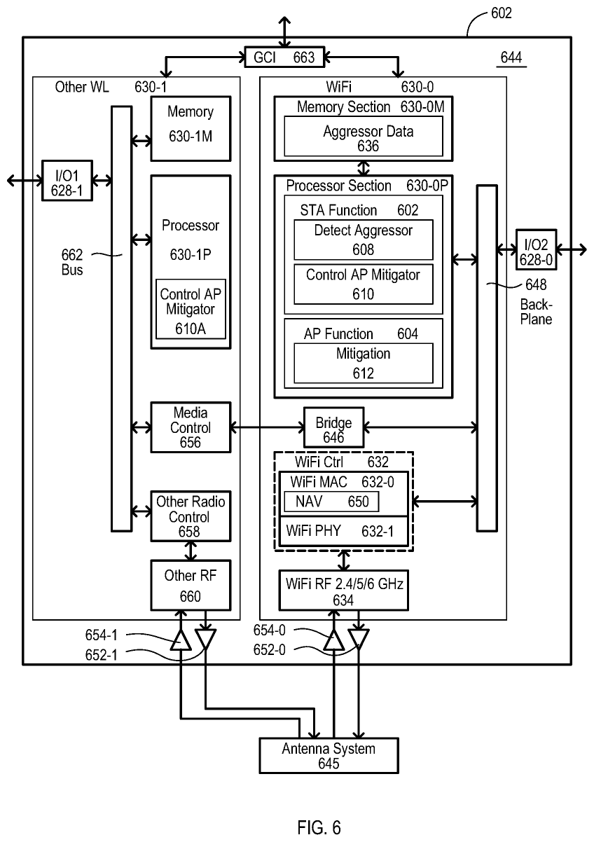

FIG. 6 is a block diagram of a system 600 according to another embodiment. In some embodiments, a system 600 can be an implementation of any of those shown herein, or equivalents. A system 600 can include Wi-Fi circuits 630-0, other wireless (WL) circuits 630-1, and an antenna system 645.

Wi-Fi circuits 630-0 can include a processor section 630-0P, a memory section 630-0M, first IO circuits 628-0, bridge control circuit 646, Wi-Fi control circuits 632 and Wi-Fi radio circuits 634. A processor section 630-0P can include one or more processors that execute instructions for Wi-Fi operations, including a STA function 602 and an AP function 604. A STA function 602 can detect aggressor devices 208 according to any of the embodiments described herein or equivalents. A STA function 602 can also include an AP mitigator control function 610. Such a function can include starting up an AP function 604 to perform mitigation operations 612, as described herein, and equivalents. An AP function 604 can execute AP operations as described herein, and equivalents, including mitigation operations 612.

A memory section 630-0M can include memory circuits for storing data accessible by a system 600, including by a processor section 630-0P. Such data can include instructions executable by a processor section 630-0P to provide the noted functions. Such data can also include data related to aggressor devices 636, as described herein and equivalents, including but not limited to: pattern data of transmissions from interferer/aggressor devices and/or address data for such devices.

First IO circuits 628-0 can enable communication with the system 600 according to any suitable interface, including a serial interface or parallel interface. In some embodiments, first IO circuits 628-0 can be compatible with one or more serial standards, including but not limited to: an SPI standard, I²C standard, USB standard, CAN bus, PCI Express and/or a proprietary standard.

Wi-Fi control circuits 632 can include circuits for performing functions according to one or more IEEE 802.11 wireless standards, including those operating in the 2.4, 5 or 6 GHz band. In some embodiments, this can include IEEE 802.11 compatible media access control layer (MAC) circuits 632-0 and IEEE 802.11 compatible physical interface layer (PHY) circuits 632-1. MAC circuits 632-0 can establish a NAV 650, which can be reset by some mitigation operations 612, as described herein and equivalents. Wi-Fi RF circuits 634 can include multi-band radio circuits that transmit and receive data on one or more Wi-Fi bands (e.g., 2.4, 5, 6 GHz). In the embodiment shown, Wi-Fi RF circuits 634 can drive one or more power amplifiers (PAS) 652-0 and receive input signals from on one or more low noise amplifiers (LNAs) 654-0.

Processor section 630-0P, bridge control circuit 646, and Wi-Fi control circuits 632 can be in communication with one another over a backplane 648.

Other WL circuits 630-1 can provide wireless communications according to one or more other (i.e., not Wi-Fi) wireless standards. Such other wireless standards can include but are not limited to a Bluetooth standard (including BLE), a Zigbee standard and/or one or more cellular standards. Other WL circuits 630-1 can include a processor section 630-1P, a memory section 630-1P, media control circuits 656, second IO circuits 628-1, and other radio control circuits 658 connected to one another by a bus 662.

Processor section 630-1P can execute instructions for other wireless operations. Memory section 630-1M can store data for executing other wireless operations, including those for processor section 630-1P. In some embodiments, processor section 630-1P can include an AP mitigation control function 610A. In response to determining transmissions from an aggressor device is affecting performance due to an aggressor device, AP mitigation control function 610A can activate mitigation operations 612 of AP function 604. When the aggressor transmissions are no longer affecting operations, AP mitigation control function 610A can de-activate mitigation operations 612 of AP function 604.

Other RF circuits 660 can be controlled by other radio control circuits 658 and can include radio circuits to enable transmission of messages according to the one or more other WL standards. In the embodiment shown, other WL RF circuits 660 can drive one or more PAs 652-1 and receive input signals from one or more LNAs 654-1.

Media control circuits 656 can communicate with Wi-Fi circuits 630-0 over bridge circuits 646 to control access to a transmission media (e.g., 2.4 GHz band). In some embodiments, such a communication path can be used by processor section 630-1P enable mitigation operations 612 from Wi-Fi circuits 630-0. Second IO circuits 628-1 can enable communication with device 600 according to any of the embodiments described herein or equivalents.

Wi-Fi circuits 630-0 and other WL circuits 630-1 can be in communication with a coexistence interface 663. A coexistence interface 663 can enable Wi-Fi circuits 630-0 and other WL circuits 630-1 to interface with other wireless systems, such as cellular network systems, including but not limited to 3G, 4G, LTE and 5G networks.

In this way, a device can include Wi-Fi circuits and other wireless circuits. Wi-Fi circuits can implement a Wi-Fi STA device that can activate an included AP device, to cause the AP device to start mitigation operations to address an interfering or aggressive wireless device. The other wireless circuits can also cause the AP device to start mitigation operations.

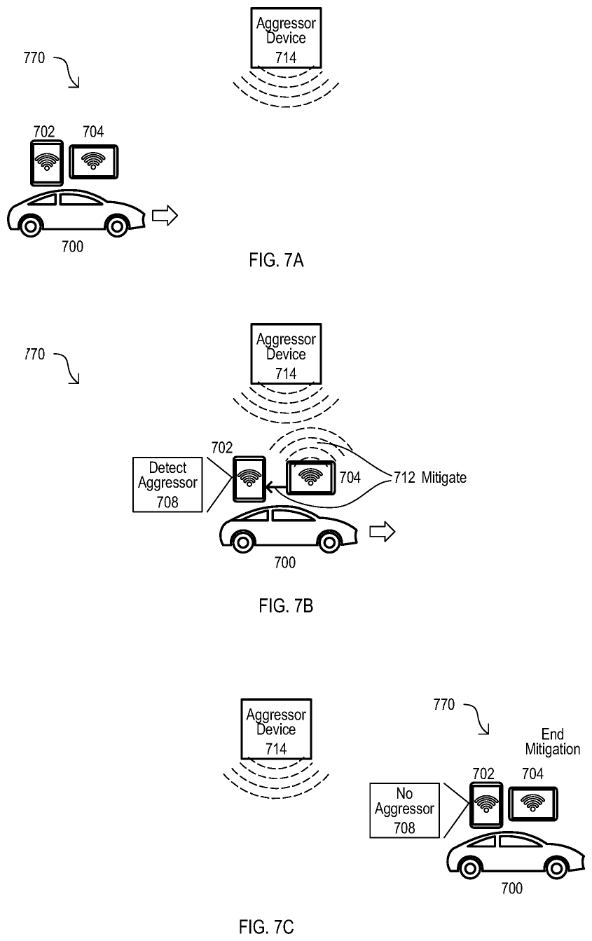

While embodiments can address interfering/aggressor devices in any suitable applications, some embodiments can include wireless systems in automobiles. FIGS. 7A to 7C are diagrams showing operations 770 of an automobile system 700 according to an embodiment. An automobile system 700 can include a STA (device or function) 702 and an AP (device or function) 704.

FIG. 7A shows an automobile system 700 that can be sufficiently far from an aggressor device 714 that its operations are not affected.

FIG. 7B shows an automobile system 700 that has moved sufficiently close to an aggressor device 714. An aggressor device 714 can take the form of any of those described herein, including but not limited to a fixed wireless access device (FWA) as described herein or equivalents. A FWA can repeatedly transmit packets resulting in long NAV times for STA 702. The adverse effects of the aggressor device 714 can be detected 708 by a STA 702, as described herein and equivalents. In response to detecting aggressor device 714 transmissions, a STA 702 can activate AP 704 to initiate mitigation operations 712. In some embodiments, an AP 704 may not be active, and a STA 702 can activate the AP 704 and the AP 704 can execute mitigation operations 712. In some embodiments, an AP 704 can be active and include detection circuits but may not detect an aggressor device 714. Mitigation operations 712 can include wireless transmissions and/or a wired transmissions to a STA 702 (e.g., wired transmission instructing STA to change operations).

FIG. 7C shows an automobile system 700 that has moved sufficiently away from an aggressor device 714 such that STA 702 no longer detects aggressor device 714. As a result, STA 702 can signal AP 704 to end mitigation operations and/or for the AP 704 to deactivate.

In this way, when an automobile with a STA moves within range of an aggressor device, upon detecting the aggressor device, the STA can activate an AP device to activate its mitigation operations. Once the STA no longer detects the aggressor device, it can de-activate the AP and/or the mitigation operations of the AP.

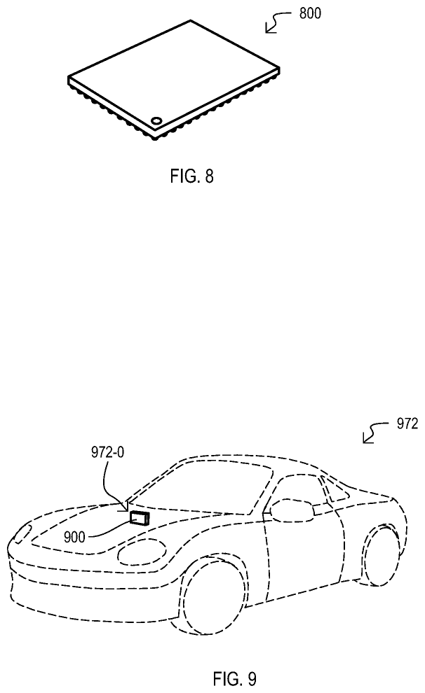

While embodiments can include devices and systems with various interconnected components, embodiments can also include unitary devices which can execute STA and AP mitigation functions as described herein. In some embodiments, such unitary devices can be advantageously compact single integrated circuits (i.e., chips). FIG. 8 shows a packaged single chip device 800, which can include STA functions and AP functions as described herein and equivalents. A device according to embodiments can include any other suitable integrated circuit packaging type, as well as direct bonding of a device chip onto a circuit board or substrate.

In this way, a wireless integrated circuit device can include a STA function and an AP function, where the STA function can activate mitigation operations of the AP function.

Embodiments can include any suitable system in which a wireless system can move within the range of an interference/aggressor device, such as an automobile system. FIG. 9 shows an automobile system 972 according to an embodiment. An automobile system 972 can have numerous sub-systems (one shown as 972-0) that can include wireless communications, such as a Wi-Fi hot spot. A sub-system 972-0 can include a wireless system 900 that can include a first device (e.g., STA) that can detect an interfering/aggressive device, and then activate a second device (e.g., AP) to start operations to mitigate the interferer/aggressor, as described for the various embodiments herein and equivalents.

In this way, an automobile can benefit from a wireless system that can include one device that detects an aggressor device and then activate another device to execute mitigation operations to address the adverse effects of the aggressor device.

While embodiments can include the various methods described for system and operations herein, additional methods will now be described with reference to flow diagrams.

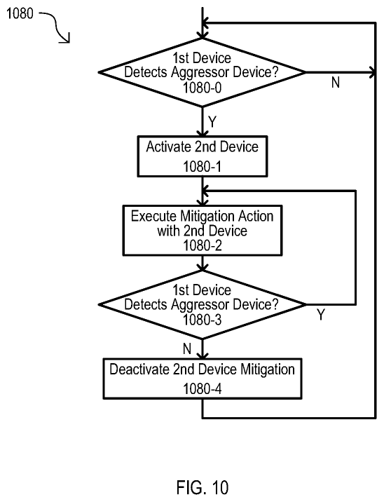

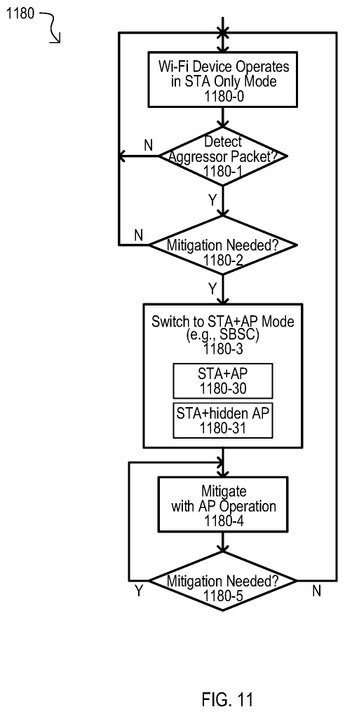

FIG. 10 is a flow diagram of a method 1080 according to an embodiment. A method 1080 can be executed by a wireless system and/or devices. A method 1080 can include determining if a first device has detected another aggressor device 1080-0. Such an action can include any of those described herein, or equivalents, including but not limited to determining if wireless transmissions are being emitted by another device, and if such transmissions exceed a predetermined threshold. Such thresholds can include but are not limited to number of transmissions, type of transmission, length of medium reservation, pattern of transmissions or reservations. If an aggressor device is detected (N from 1080-0), a first device can continue to monitor for aggressor devices.

If an aggressor device is detected (Y from 1080-0), a second device can be activated 1080-1. Such an action can include enabling an existing device or configuring a device with software. Once a second device is activated, the second device can execute a mitigation operation 1080-2. A mitigation operation can take the form of any of those described herein or equivalents, including but not limited to command based mitigation (e.g., control messages according to a standard) or embedded data (e.g., IE) based mitigation, in which the data in a message indicates actions to be taken by a first device.

While mitigation operations are being executed by a second device, a first device can continue to determine if there is an aggressor device 1080-3. If an aggressor device continues to be detected (Y from 1080-3), the second device can continue mitigation actions. If an aggressor device is no longer detected (N from 1080-3), mitigation actions of a second device can be deactivated 1080-4.

In this way, when an aggressor device is detected by one device, the one device can activate a second device to execute mitigation actions to address the adverse effects of the aggressor device.

FIG. 11 is a flow diagram of a method 1180 according to another embodiment. A method 1180 can be executed by a Wi-Fi device that has both STA and AP functions, with the AP function having mitigation abilities, as described herein and equivalents. A method 1180 can include a Wi-Fi device operating in a STA only mode 1180-0. Such an action can include a device enabling a STA function while an AP function remains disabled. A method 1180 can determine if an aggressor packet has been detected 1180-1. Such an action can include detecting one or more packets that may result in undesirable limits to an operating channel for a STA. If an aggressor packet is not detected (N from 1180-1), a method 1180 can continue operations in a STA only mode.

If an aggressor packet is detected (Y from 1180-1), a determination can be made as to whether mitigation is needed 1180-2. Such an action can include determining if a STA can access a wireless channel within a predetermined amount of time and/or if an aggressor packet(s) reserves or otherwise occupies a channel for too much time. If mitigation is not needed (N from 1180-2), a method 1180 can keep operating in STA only mode and continue to detect aggressor packets.

If mitigation is needed (Y from 1180-2), a method 1180 can switch to a STA+AP mode 1180-3. In some embodiments, such an action can include starting up a softAP. Operating in a STA+AP mode 1180-3 can include an AP operating in a visible mode 1180-30 (i.e., it can transmit an SSID) or a hidden mode (i.e., it does not transmit an SSID). In some embodiments, in a STA+AP mode 1180-3, as an AP starts up, it will automatically select the same band and channel as the STA (e.g., SBSC). Once in the STA+AP mode, AP operations can result in mitigation actions from AP operations 1180-4 to address an aggressor device. In some embodiments, such mitigation actions 1180-4 can occur without an AP detecting the aggressor packets.

Once mitigation operations are occurring, a method 1080 can check to determine if mitigation is still needed 1180-5. If mitigation is still needed (Y from 1180-5) mitigation can continue. If mitigation is no longer needed (N from 1180-5), a method 1180 can return to STA only mode (1180-0).

In this way, a STA device that detects an aggressor device can switch to a STA+AP mode and utilize AP mitigation operations to improve access to the channel. When the aggressor device is no longer detected, operations can return to a STA only mode.

Embodiments can include methods, devices and systems that can, by operation of a first wireless device operating on a channel of a wireless network, determining if another wireless device operating outside of the wireless network is interfering with operations of the first wireless device on the channel. In response to determining that the other wireless device is interfering with operations, a second wireless device can be activated to execute a mitigation operation to improve the first wireless device access to the channel. Following the activation of the second wireless device, in response to the first wireless device determining that the other wireless device is not interfering with its operations, deactivating the second wireless device.

Embodiments can include methods, devices and systems that can include wireless circuits configured to communicate according to at least one wireless communication protocol and controller circuits. Controller circuits can be configured to monitor communications on a wireless channel that is part of a network. In response to determining that another wireless device, outside of the network, is interfering with communications of the device on the wireless channel, an activation indication can be generated that is configured to cause a second wireless device to mitigate the interference of the other device on the channel. In response to determining that the other wireless device is no longer interfering with communications, generating a deactivation indication configured to deactivate at least mitigation operations of the second wireless device.

Embodiments can include methods, devices and systems that can include a first wireless device comprising controller circuits and wireless circuits and configured to monitor communications on a channel that is part of a network. In response to determining that an out-of-network wireless device is interfering with the first wireless device accessing the channel, the first wireless device can activate at least mitigation operations of a second wireless device. In response to determining that an out-of-network wireless device is no longer interfering with the first wireless device accessing the channel, the first wireless device can deactivate at least the mitigation operations of the second wireless device. The second wireless device can be configured to generate transmissions to improve access to the channel by the first wireless device when activating the mitigation operations and cease the transmissions when deactivating the mitigation operations.

Methods, devices and systems according to embodiments can include a first wireless device that is a STA compatible with at least one IEEE 802.11 wireless standard and a second wireless device is an AP compatible with the at least one IEEE 802.11 wireless standard.

Methods, devices and systems according to embodiments can include a STA that is part of a communication system having at least one processor. Activating a second wireless device can include starting up a soft AP device by executing predetermined code with the at least one processor.

Methods, devices and systems according to embodiments can include starting up the AP to operate in the same channel as the STA.

Methods, devices and systems according to embodiments can include determining a network address of the other wireless device.

Methods, devices and systems according to embodiments can include, upon activation, a second wireless device can be configured to execute the mitigation operation without the second wireless device determining if there is interference on the channel.

Methods, devices and systems according to embodiments can include wireless circuits that are compatible with at least one IEEE 802.11 wireless standard.

Methods, devices and systems according to embodiments can include controller circuits are configured to operate as a STA of the network. The STA can be configured to monitor communications on the wireless channel, determine that another wireless device is interfering with communications, and startup a softAP device configured to generate at least one wireless mitigation communication.

Methods, devices and systems according to embodiments can include a STA that is configured to generate a RTS frame and a softAP can be configured to generate a clear-to-send (CTS) frame in response to the RTS frame regardless of the channel status as the at least one wireless mitigation communication.

Methods, devices and systems according to embodiments can include a STA configured to clear its network allocation vector in response to the at least one wireless mitigation communication.

Methods, devices and systems according to embodiments can include controller circuits are configured to, in response to generating the activation indication, receive a packet from the second wireless device, extract data from the packet, and alter wireless operations of the device in response to data extracted from the packet. A mitigation operation of a second wireless device can include the packet. In some embodiments, altered wireless operations are selected from the group of ignoring requests to reserve the channel, switching a channel on which to communicate, and ignore communications from the second wireless device.

Methods, devices and systems according to embodiments can include wireless circuits, controller circuits and second wireless device formed with a same integrated circuits substrate.

Methods, devices and systems according to embodiments can include wireless a second wireless device comprises a software entity. Activating a second wireless device can include starting up the software entity.

Methods, devices and systems according to embodiments can include wireless a second wireless device comprises a software entity. Activating a second wireless device can include starting up the software entity.

Methods, devices and systems according to embodiments can include second wireless device that comprises a hidden AP that does not broadcast a SSID.

Methods, devices and systems according to embodiments can include a second wireless device that includes a soft AP that operates in a same channel as the first wireless device.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
by operation of a first wireless device operating on a channel of a wireless network,
determining if another wireless device operating outside of the wireless network is interfering with operations of the first wireless device on the channel,
in response to determining the other wireless device is interfering with operations, activating a second wireless device to execute a mitigation operation to improve the first wireless device access to the channel, and
following the activation of the second wireless device, in response to the first wireless device determining that the other wireless device is not interfering with its operations, deactivating the second wireless device.

2. The method of claim 1, wherein:
the first wireless device is a station device (STA) compatible with at least one IEEE 802.11 wireless standard; and
the second wireless device is an access point device (AP) compatible with the at least one IEEE 802.11 wireless standard.

3. The method of claim 2, wherein:
the STA is part of a communication system having at least one processor; and
activating the second wireless device includes starting up a soft AP device by executing predetermined code with the at least one processor.

4. The method of claim 2, wherein activating the second wireless device includes starting up the AP to operate in the same channel as the STA.

5. The method of claim 1, wherein determining if another wireless device is interfering with operations of the first wireless device includes determining a network address of the other wireless device.

6. The method of claim 5, wherein determining if another wireless device is interfering with operations of the first wireless device further includes determining if packets from the other wireless device prevent access to the channel.

7. The method of claim 1, wherein, upon activation, the second wireless device is configured to execute the mitigation operation without the second wireless device determining if there is interference on the channel.

8. A device, comprising:
wireless circuits configured to communicate according to at least one wireless communication protocol; and
controller circuits configured to
monitor communications on a wireless channel that is part of a network,
in response to determining that another wireless device, outside of the network, is interfering with communications of the device on the wireless channel, generating an activation indication that is configured to cause a second wireless device to mitigate the interference of the other device on the channel, and
in response to determining that the other wireless device is no longer interfering with communications, generating a deactivation indication configured to deactivate at least mitigation operations of the second wireless device.

9. The device of claim 8, wherein the wireless circuits are compatible with at least one IEEE 802.11 wireless standard.

10. The device of claim 9, wherein:
the controller circuits are configured to
operate as a station device (STA) of the network, the STA configured to
monitor communications on the wireless channel,
determine that another wireless device is interfering with communications, and
startup a soft access point (AP) device configured to generate at least one wireless mitigation communication.

11. The device of claim 10, wherein:
the STA is configured to generate a request-to-send (RTS) frame; and
the soft AP is configured to generate a clear-to-send (CTS) frame in response to the RTS frame regardless of the channel status as the at least one wireless mitigation communication.

12. The device of claim 10, wherein the STA is configured to clear its network allocation vector in response to the at least one wireless mitigation communication.

13. The device of claim 8, wherein:
the controller circuits are configured to, in response to generating the activation indication,
receive a packet from the second wireless device,
extract data from the packet, and
alter wireless operations of the device in response to data extracted from the packet; wherein
the mitigation operation of the second wireless device comprises the packet.

14. The device of claim 13, wherein the altered wireless operations are selected from the group of: ignoring requests to reserve the channel, switching a channel on which to communicate, and ignore communications from the other wireless device.

15. The device of claim 8, wherein the wireless circuits, controller circuits and second wireless device are formed with a same integrated circuits substrate.

16. A system, comprising:
a first wireless device comprising controller circuits and wireless circuits and configured to
monitor communications on a channel that is part of a network,
in response to determining that an out-of-network wireless device is interfering with the first wireless device's access to the channel, activating at least mitigation operations of a second wireless device; and
in response to determining that an out-of-network wireless device is no longer interfering with the first wireless device's access to the channel, deactivating at least the mitigation operations of the second wireless device; and
the second wireless device is configured to
generate transmissions to improve access to the channel by the first wireless device when activating the mitigation operations, and
cease the transmissions when deactivating the mitigation operations.

17. The system of claim 16, wherein:
the second wireless device comprises a software entity; and
activating the second wireless device includes starting up the software entity.

18. The system of claim 16, wherein:
the first wireless device comprises a station device compatible with at least one IEEE 802.11 wireless standard; and
the second wireless device comprises an access point device (AP) compatible with the at least one IEEE 802.11 wireless standard.

19. The system of claim 18, wherein the second wireless device comprises a hidden AP that does not broadcast a service set identification (SSID).

20. The system of claim 18, wherein activating the second wireless devices includes starting up a soft AP that operates in the channel.
